(19) United States
(12) Patent Application Publication
(10) Pub. No.: US 2018/0163784 A1
(43) Pub. Date: Jun. 14, 2018

(54) NEEDLE BEARING UNIT FOR MOUNTING A VALVE SHAFT OR ACTUATOR SHAFT AND GAS CONTROL VALVE ARRANGEMENT

(71) Applicant: Schaeffler Technologies AG & Co. KG, Herzogenaurach (DE)

(72) Inventors: Birger Wollboldt, Babenhausen (DE); Jörg Rathmann, Erlangen (DE); Andre Anger, Uehlfeld (DE)

(73) Assignee: Schaeffler Technologies AG & Co. KG, Herzogenaurach (DE)

(21) Appl. No.: 15/569,835

(22) PCT Filed: Mar. 2, 2016
(86) PCT No.: PCT/DE2016/200116

§ 371 Date: Feb. 5, 2018

(30) Foreign Application Priority Data
Apr. 27, 2015 (DE) 10 2015 207 655.5

(51) Int. Cl. F16C 33/58; F16C 19/46; F16K 31/44

(52) U.S. Cl. CPC F16C 33/58; F16C 2361/91; F16K 31/44; F16C 19/46

(57) ABSTRACT

Needle bearing units and gas control valve arrangements including the bearing units are disclosed. A needle bearing unit for mounting a valve shaft or actuator shaft may include an outer ring and a needle cage, which may be arranged in the outer ring. Needle-shaped rolling elements may be guided in the needle cage, and the outer ring may have the form of a sleeve and have a sleeve bottom at its first end. An inner ring may be arranged in the needle cage and have, at its end remote from the sleeve bottom, an inner ring flange pointing toward the outer ring. The outer ring may have, at its second end, a sleeve flange, which surrounds the inner ring flange in order to fix the inner ring in the outer ring.

The invention relates to a needle bearing unit for mounting a valve shaft or actuator shaft, having an outer ring, a needle cage, which is arranged in the outer ring, and needle-shaped rolling elements, which are guided in the needle cage. The invention furthermore relates to a gas control valve arrangement comprising a rotatable valve shaft and a gas control valve arranged on the valve shaft.

Rolling bearing units, especially needle bearing units, for mounting valve shafts or actuator shafts are known. Thus, DE 10 2006 053 716 A1 discloses a rolling bearing unit of the type stated at the outset which is used to mount a valve shaft on a gas valve control arrangement. In this case, use is made of a plurality of sealing rings, which are accommodated in the outer ring and are designed to seal against fluids flowing along an axis of rotation of the valve shaft. Here, sealing rings are provided at both ends of a sleeve-shaped outer ring.

In this case, the rolling elements run directly on the valve shaft, leading to problems with increased wear. Valve shafts with ground and hard-chrome plated ends are therefore usually used as supports for the needle bearing units. The preparation of the shaft ends is an involved and expensive process.

It is an object of the invention to provide a needle bearing unit for mounting a valve shaft or actuator shaft, which can be produced in a particularly simple and low-cost way. It is furthermore an object of the invention to provide a gas control valve arrangement having a needle bearing unit of this kind.

In respect of the needle bearing unit for mounting a valve shaft or actuator shaft, having an outer ring, a needle cage, which is arranged in the outer ring, and needle-shaped rolling elements, which are guided in the needle cage, the object is that the outer ring has the form of a sleeve and has a sleeve bottom at its first end, in that there is furthermore an inner ring, which is arranged in the needle cage and has, at its end remote from the sleeve bottom, an inner ring flange pointing toward the outer ring, and in that the outer ring has, at its second end, a sleeve flange, which surrounds the inner ring flange in order to fix the inner ring in the outer ring.

A sealing ring between the needle cage and the sleeve bottom of the first end of the outer ring can therefore be dispensed with. As a result, the needle bearing unit according to the invention can be assembled from the outer ring, the needle cage, the rolling elements and the inner ring. The assembly of the needle bearing unit from the individual parts can be carried out quickly and inexpensively.

A gap formed between the inner ring flange and the sleeve flange preferably has a gap dimension of less than 1 mm, in particular of less than 0.7 mm. Here, the gap forms a gap or labyrinth seal, which can replace a sealing ring.

It has proven advantageous if the inner ring is a deep-drawn hardened inner ring. In particular, steel or stainless steel, especially X5 CrNi1810, is used to form the inner ring. In an alternative embodiment, the inner ring can also be produced by machining or can be formed partially by machining and partially without machining.

The inner ring preferably has a wall thickness in a range of from 0.5 to 3 mm. This enables the inner ring to be press fitted onto a valve shaft or actuator shaft without problems.

The sleeve-shaped outer ring is preferably also formed from steel or stainless steel, especially X5 CrNi1810, wherein hardened or unhardened grades can be used. It has proven advantageous if the sleeve-shaped outer ring is produced without machining, in particular by deep drawing. In an alternative embodiment, it is also possible for the outer ring to be produced by machining or partially by machining and partially without machining.

The needle cage is preferably formed from plastic, steel or stainless steel.

In a preferred embodiment of the needle bearing unit, there is furthermore at least one sealing ring, which is arranged between the needle cage and the inner ring flange. This can have one or more sealing lips. The sealing ring is preferably formed from nitrile rubber (NBR) or fluorinated rubber (FPM).

The object is furthermore achieved, in respect of the gas control valve arrangement comprising a rotatable valve shaft and a gas control valve arranged on the valve shaft, if the valve shaft is mounted at at least one end by means of a needle bearing unit according to the invention, wherein one end of the valve shaft is inserted into the sleeve-shaped outer ring, and the inner ring is connected to the end of the valve shaft by press fitting. Low-cost and durable mounting of the valve shaft is thereby achieved. Grinding and hard-chrome plating of the valve shaft, as is customary, can be omitted since the inner ring serves as the running surface for the rolling elements and reduces the axial shaft play. In particular, wear in the region of the inner ring is reduced if a hardened inner ring is used.

The valve shaft is preferably mounted by means of the needle bearing unit according to the invention on one side of the gas control valve and is mounted by means of a further needle bearing unit on an opposite side of the gas control valve, which further needle bearing unit has a sleeve-shaped further outer ring, which, at the first end thereof and the second end thereof, has a respective flange pointing toward the valve shaft, a further needle cage, which is arranged in the further outer ring, and needle-shaped rolling elements, which are guided in the further needle cage, and at least one further sealing ring, wherein, on the one hand, the further needle cage adjoins the flange of the first end of the further outer ring and, on the other hand, the at least one further sealing ring is arranged between the further needle cage and the flange of the second end of the further outer ring.

The flange at the first end of the further outer ring of the further needle bearing unit preferably forms a gap seal with respect to the valve shaft in that the flange has an inside diameter which is no more than 0.1 to 1 mm larger than an outside diameter of the valve shaft. The gap seal thereby formed reliably replaces a sealing ring at the first end of the further outer ring.

The first end of the further outer ring of the further needle bearing unit is preferably arranged facing the gas control valve. As an alternative, the second end of the further outer ring can be arranged facing the gas control valve.

The needle bearing unit according to the invention and the gas valve control arrangement according to the invention are advantageous especially for uses in the internal combustion engine sector, especially in the motor vehicle industry.

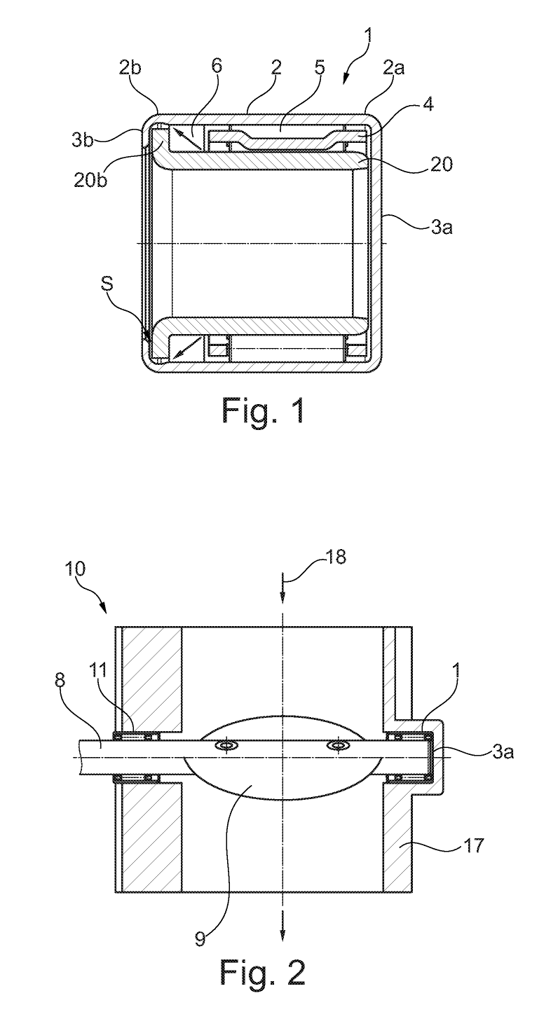

FIGS. 1 to 5 show, by way of example, a needle bearing unit according to the invention and a gas valve control arrangement formed thereby. Thus:

FIG. 1 shows a needle bearing unit in section;

FIG. 2 shows a gas valve control arrangement in section;

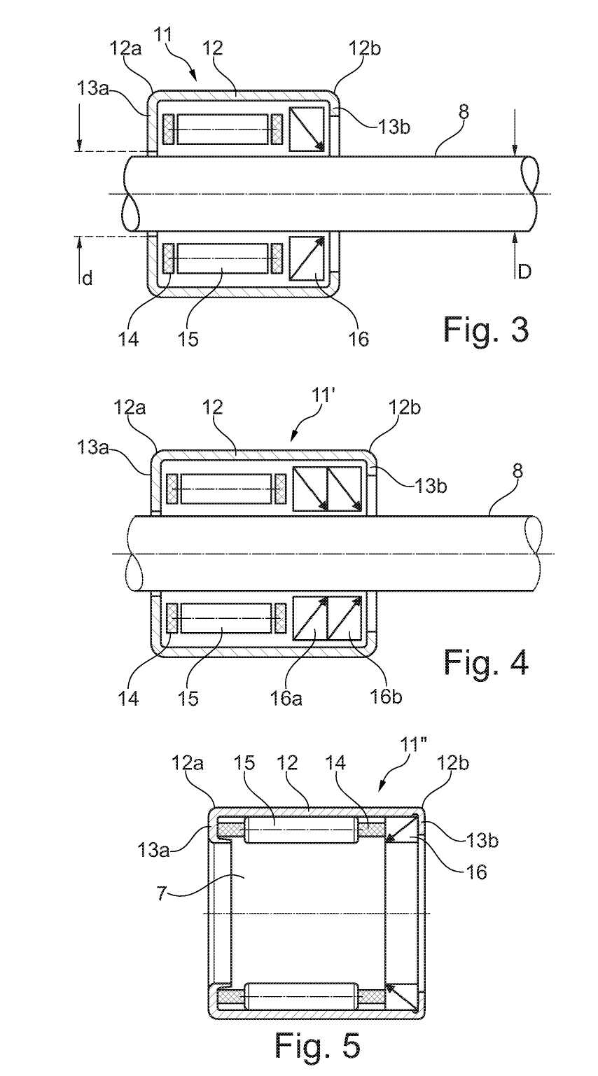

FIG. 3 shows a first further needle bearing unit, having a sealing ring, in section;

FIG. 4 shows a second further needle bearing unit, having two sealing rings, in section; and

FIG. 5 shows a third further needle bearing unit in section.

FIG. 1 shows a needle bearing unit 1 in section. The needle bearing unit 1 has an outer ring 2, a needle cage 4, which is arranged in the outer ring 2, and needle-shaped rolling elements 5, which are guided in the needle cage 4. The outer ring 2 has the form of a sleeve and has a sleeve bottom 3a at its first end 2a. There is furthermore an inner ring 20, which is arranged in the needle cage 4 and has, at its end remote from the sleeve bottom 3a, an inner ring flange 20b pointing toward the outer ring 2. The outer ring 2 has, at its second end 2b, a sleeve flange 3b, which surrounds the inner ring flange 20b in order to fix the inner ring 20 in the outer ring 2. In this case, the inner ring 20 is a deep-drawn hardened inner ring 20.

FIG. 2 shows a gas valve control arrangement 10 having a gas-carrying line 17 in section. The same reference signs as in FIG. 1 denote the same elements. The valve shaft 8 is rotatably mounted (see double arrow) in the region of the gas-carrying line 17 by means of a needle bearing unit 1 in accordance with FIG. 1 and furthermore by means of a further needle bearing unit 11 in accordance with FIG. 3. Arranged on the valve shaft 8 is a gas control valve 9, which moves with the valve shaft 8 in the gas-carrying line 17, which carries a gas 18. One end of the valve shaft 8 is inserted into the sleeve-shaped outer ring 2 of the needle bearing unit 1, and the inner ring 20 is connected to the end of the valve shaft 8 by press fitting (see also FIG. 1). The sealing direction of the sealing ring 6 with respect to that portion of the gas 18 which flows in the direction of the valve shaft 8 is indicated by arrows (see FIG. 1).

On its side facing the gas control valve 9, the inner ring 20 has an inner ring flange 20b pointing away from the valve shaft 8. On its side facing the gas control valve 9, the sleeve-shaped outer ring 2 has a sleeve flange 3b pointing toward the valve shaft 8. To fix the inner ring 20 in the sleeve-shaped outer ring 2, the sleeve flange 3b surrounds the inner ring flange 20b, wherein a gap S having a gap dimension of less than 0.7 mm is formed. Here, the gap S forms a gap or labyrinth seal. To this extent, it would also be possible here, in an alternative embodiment of the needle bearing unit 1, to dispense with the sealing ring 6.

FIG. 3 shows another needle bearing unit 11 for mounting the valve shaft 8 in section, having a sleeve-shaped further outer ring 12, a further needle cage 14, which is arranged in the further outer ring 12, and further needle-shaped rolling elements 15, which are guided in the further needle cage 14, and having a further sealing ring 16. At its first end 12a and its second end 12b, the sleeve-shaped further outer ring 12 has a respective flange 13a, 13b. On the one hand, the needle cage 14 adjoins the flange 13a of the first end 12a of the further outer ring 12. On the other hand, the further sealing ring 16 is arranged between the further needle cage 14 and the flange 13b of the second end 12b of the further outer ring 12. The sealing direction of the further sealing ring 16 with respect to fluids flowing in the direction of the valve shaft 8 is indicated by arrows. The flange 13a at the first end 12a of the further outer ring 12 forms a gap seal with respect to the valve shaft 8 of the gas control valve arrangement 10 (see FIG. 2) in that the flange 13a has an inside diameter d which is no more than 0.1 to 1 mm larger than an outside diameter D of the valve shaft 8.

FIG. 4 shows a second further needle bearing unit 11′ having two further sealing rings 16a, 16b in section. The same reference signs as in FIG. 3 denote the same elements. The sealing directions of the further sealing rings 16a, 16b with respect to fluids flowing in the direction of the valve shaft 8 are indicated by arrows.

FIG. 5 shows a third further needle bearing unit 11″ having a sealing ring 6 in section. The same reference signs as in FIG. 1 denote the same elements. The sealing direction of the further sealing ring 6 with respect to fluids flowing in the direction of a valve shaft or actuator shaft (not shown here) is indicated by arrows. The flange 13a at the first end 12a of the further outer ring 12 is in the form of a U profile and projects into a cavity 7 formed by the further needle cage 14. The flange 13a thereby fixes the further needle cage 14 in the further outer ring 12.

A gas valve control arrangement 10 which manages with a minimum of sealing rings 6, 16 and can be produced in a particularly simple and low-cost way is obtained.

Here, FIGS. 1 to 5 merely show illustrative embodiments of a needle bearing unit or gas valve control arrangement according to the invention. Thus, the valve shaft of the gas valve control arrangement can also be mounted by means of two needle bearing units according to the invention.

### LIST OF REFERENCE SIGNS

1 needle bearing unit
2 sleeve-shaped outer ring
2a first end of the sleeve-shaped outer ring
2b second end of the sleeve-shaped outer ring
3a sleeve bottom
3b sleeve flange
4 needle cage
5 rolling elements
6 sealing ring
7 cavity
8 valve shaft
9 gas control valve
10 gas control valve arrangement
11, 11′, 11″ further needle bearing unit
12 sleeve-shaped further outer ring
12a first end of the further outer ring
12b second end of the further outer ring
13a, 13b flange
14 further needle cage
15 further rolling elements
16, 16a, 16b further sealing ring
17 gas-carrying line
18 gas
20 inner ring
20b inner ring flange
D outside diameter of the valve shaft
d inside diameter at the flange 13a
S gap

1. A needle bearing unit for mounting a valve shaft or actuator shaft, comprising:
an outer ring, a needle cage, which is arranged in the outer ring, and needle-shaped rolling elements, which are guided in the needle cage, the outer ring having the form of a sleeve and having a sleeve bottom at its first end; and
an inner ring, which is arranged in the needle cage and has, at its end remote from the sleeve bottom, an inner ring flange pointing toward the outer ring, and in that the outer ring has, at its second end, a sleeve flange, which surrounds the inner ring flange in order to fix the inner ring in the outer ring.

2. The needle bearing unit as claimed in claim 1, wherein the inner ring is a deep-drawn hardened inner ring.

3. The needle bearing unit as claimed in claim 1, wherein the inner ring has a wall thickness in a range of from 0.5 to 3 mm.

4. The needle bearing unit as claimed in claim 1, wherein a gap is formed between the inner ring flange and the sleeve flange and has a gap dimension of less than 1 mm.

5. The needle bearing unit as claimed in claim 1, further comprising at least one sealing ring, which is arranged between the needle cage and the inner ring flange.

6. A gas control valve arrangement comprising a rotatable valve shaft and a gas control valve arranged on the valve shaft, wherein the valve shaft is mounted at at least one end by means of a needle bearing unit as claimed in claim 1, wherein one end of the valve shaft is inserted into the sleeve-shaped outer ring, and the inner ring is connected to the end of the valve shaft by press fitting.

7. The gas control valve arrangement as claimed in claim 6, wherein the valve shaft is mounted on the needle bearing unit on one side of the gas control valve and is mounted on a further needle bearing unit on an opposite side of the gas control valve, which further needle bearing unit has a sleeve-shaped further outer ring, which, at the first end thereof and the second end thereof, has a respective flange pointing toward the valve shaft, a further needle cage, which is arranged in the further outer ring, and needle-shaped rolling elements, which are guided in the further needle cage, and at least one further sealing ring, wherein, the further needle cage adjoins the flange of the first end of the further outer ring and the at least one further sealing ring is arranged between the further needle cage and the flange of the second end of the further outer ring.

8. The gas control valve arrangement as claimed in claim 7, wherein the flange at the first end of the further outer ring of the further needle bearing unit forms a gap seal with respect to the valve shaft in that the flange has an inside diameter which is no more than 0.1 to 1 mm larger than an outside diameter (D) of the valve shaft.

9. The gas control valve arrangement as claimed in claim 7, wherein the first end of the further outer ring is arranged facing the gas control valve.

10. The gas control valve arrangement as claimed in claim 7, wherein the second end of the further outer ring is arranged facing the gas control valve.

11. A needle bearing unit, comprising:
an outer ring shaped as a sleeve and having a sleeve bottom at a first end;
a needle cage arranged in the outer ring;
needle-shaped rolling elements, which are guided in the needle cage; and
an inner ring arranged in the needle cage and having, at an end remote from the sleeve bottom, an inner ring flange extending toward the outer ring;
wherein the outer ring has, at a second end, a sleeve flange that surrounds the inner ring flange and fixes the inner ring in the outer ring.

12. The needle bearing unit as claimed in claim 11, wherein the inner ring is a deep-drawn hardened inner ring.

13. The needle bearing unit as claimed in claim 11, wherein the inner ring has a wall thickness in a range of from 0.5 to 3 mm.

14. The needle bearing unit as claimed in claim 11, wherein a gap is formed between the inner ring flange and the sleeve flange and has a gap dimension of less than 1 mm.

15. The needle bearing unit as claimed in claim 11, further comprising at least one sealing ring arranged between the needle cage and the inner ring flange.
